(19) United States
(12) Patent Application Publication
(10) Pub. No.: US 2010/0259210 A1
(43) Pub. Date: Oct. 14, 2010

(54) Charged/Discharged Power control for a Capacitor Type Energy Storage Device

(75) Inventors: Masakazu Sasaki, Saitama (JP); Tetsuo Saitou, Tokyo (JP)

Correspondence Address: RABIN & Berdo, PC, 1101 14TH STREET, NW, SUITE 500, WASHINGTON, DC, 20005, US

(73) Assignee: Nissan Diesel Motor Co., Ltd., Saitama (JP)

(21) Appl. No.: 11/991,786

(22) PCT Filed: Oct. 20, 2005
(86) PCT No.: PCT/JP2005/305764

§ 371 Date: Mar. 11, 2008

(30) Foreign Application Priority Data
Oct. 20, 2005 (JP) 2005-305764

(51) Int. Cl. H01M 10/44

(52) U.S. Cl. 320/101; 320/166

(57) ABSTRACT

A charge/discharge of a capacitor system (10) with stacked electric double layer capacitors is regulated by an inverter/converter (9) for stabilizing an output power of a wind power generator (1). The inverter/converter controller (53) controls the inverter/converter (9) such that, when the state of charge (SOC) of the capacitor system (10) exceeds an upper threshold (H1), which is smaller than an upper limit (H2), the charged power of the capacitor system (10) gradually decreases according to an excess amount. The inverter/converter controller (53) also controls the inverter/converter (9) such that, when the state of charge (SOC) is below a lower threshold (L1) which is higher than a lower limit (L2), the discharged power of the capacitor system (10) gradually decreases according to a short amount, thereby preventing overcharging and overdischarging of the capacitor system (10).

### FIELD OF THE INVENTION

This invention relates to a charged/discharged power control for an energy storage device using capacitors.

### BACKGROUND OF THE INVENTION

JP 2002-101557 A published by Japan Patent Office in 2002 discloses an energy storage device to stabilize the output power of a wind power generation system.

In this system, an objective level is set for the output power of a wind power generator and, when the output power of the generator exceeds the objective level, the energy storage device is charged with the excess power whereas the energy storage device discharges power to compensate for a shortage when the output power of the generator is lower than the objective level.

Overcharge and overdischarge of the energy storage device has to be avoided in order to ensure the safety and durability of the energy storage device. It is also necessary to keep the charge level of the energy storage device at a proper level so that the energy storage device can provide enough output power for stabilization of the output power of the wind power generation system.

### SUMMARY OF THE INVENTION

When lead batteries are used as the energy storage device, inherent properties of the lead batteries make it difficult to detect and figure out the charge level of the energy storage device accurately.

A solution to prevent overcharge and overdischarge of the lead batteries is to increase the capacity of the lead batteries and thus allowing a margin in charge level control, but this method raises the cost of the energy storage device.

In addition, keeping the charge level of the energy storage device at a proper level necessitates frequent maintenance of the batteries, with the result that the maintenance cost increases.

Another problem is that degradation of some of unit cells is unavoidable despite maintenance, and that replacing degraded unit cells elevates the life cycle cost.

In order to solve the above problems related to the properties of the lead batteries, the inventors had an idea to construct an energy storage device from capacitors.

The charge amount of a capacitor is expressed by the following Expression (1):

$$Charge amount = \frac{C \cdot {V}^{2}}{2} ( joule ) \qquad ( 1 )$$

wherein,
C represents static capacitance (farad) and
V represents voltage (volt).

As can be seen in Expression (1), charging and discharging of a capacitor is accompanied by a change in voltage. The state of charge (SOC) of a capacitor can therefore be figured out from the terminal voltage of the capacitor with precision.

It is therefore an object of this invention to efficiently control an energy storage device using a capacitor.

In order to achieve the above object, this invention provides an energy storage device connected to a generator to stabilize output of the generator, comprising a capacitor system comprising a number of stacked capacitors, an inverter/converter which selectively controls charging and discharging of the capacitor system, and a programmable controller.

The controller is programmed to cause the inverter/converter, when an output power of the generator exceeds an objective level, to charge the capacitor system with an excess power of the generator, cause the inverter/converter, when the output power of the generator is lower than the objective level, to make the capacitor system discharge power so as to compensate for a shortage of the output power of the generator, determine a parameter representing a charging/discharging condition of the capacitor system, and cause the inverter/converter, when the parameter exceeds a threshold that is set on near side of a limit value, to make a charged power and a discharged power of the capacitor system decrease as the parameter approaches the limit value and equal zero when the parameter reaches the limit value.

This invention also provides a control method for the energy storage device, comprising causing the inverter/converter, when an output power of the generator exceeds an objective level, to charge the capacitor system with an excess power of the generator, causing the inverter/converter, when the output power of the generator is lower than the objective level, to make the capacitor system discharge power so as to compensate for a shortage of the output power of the generator, determine a parameter representing a charging/discharging condition of the capacitor system, and causing the inverter/converter, when the parameter exceeds a threshold that is set on near side of a limit value, to make a charged power and a discharged power of the capacitor system decrease as the parameter approaches the limit value and equal zero when the parameter reaches the limit value.

This invention also provides an energy storage device connected to a generator to stabilize an output power of the generator, comprising a capacitor system comprising a number of stacked capacitors, an inverter/converter which selectively controls charging and discharging of the capacitor system, and a programmable controller.

The controller is programmed to cause the inverter/converter, when the output power of the generator exceeds an objective level, to charge the capacitor system with an excess power of the generator, cause the inverter/converter, when the output power of the generator is lower than the objective level, to cause the capacitor system to discharge power so as to compensate for a shortage of the output power of the generator, determine a state of charge of the capacitor system, cause the inverter/converter, when the state of charge is higher than a given value, to cause the capacitor system to increase the discharged power by a first bias value, and cause the inverter/converter, when the state of charge is lower than the given value, to cause the capacitor system to increase the charged power of the capacitor system by a second bias value.

This invention also provides a control method for the energy storage device, comprising causing the inverter/converter, when the output power of the generator exceeds an objective level, to charge the capacitor system with an excess power of the generator, causing the inverter/converter, when the output power of the generator is lower than the objective level, to cause the capacitor system to discharge power so as to compensate for a shortage of the output power of the generator, determining a state of charge of the capacitor system, causing the inverter/converter, when the state of charge is higher than a given value, to cause the capacitor system to increase the discharged power by a first bias value, and causing the inverter/converter, when the state of charge is lower than the given value, to cause the capacitor system to increase the charged power of the capacitor system by a second bias value.

The details as well as other features and advantages of this invention are set forth in the remainder of the specification and are shown in the accompanying drawings.

### BRIEF DESCRIPTION OF THE DRAWINGS

FIG. 1 is a schematic diagram of a wind power generation system to which an energy storage device according to this invention is applied.

FIG. 2 is a schematic diagram of the energy storage device.

FIG. 3 is a diagram illustrating the outline of charged/discharged power limitation control according to this invention.

FIG. 4 is a flow chart illustrating a charged/discharged power limitation control routine executed by an inverter/converter controller according to this invention.

FIG. 5 is a diagram illustrating possible variations of the charged/discharged power limitation control.

FIG. 6 is a diagram illustrating the outline of charged/discharged power limitation control according to a second embodiment of this invention.

FIG. 7 is a flow chart illustrating a charged/discharged power limitation control routine executed by an inverter/converter controller according to a second embodiment of this invention.

FIG. 8 is a diagram illustrating possible variations of the charged/discharged power limitation control in the second embodiment of this invention.

FIG. 9 is a diagram illustrating the relation between a running time and a state of charge (SOC) of a common capacitor system.

FIG. 10 is a diagram illustrating the outline of charged/discharged power bias control executed by an inverter/converter controller according to a third embodiment of this invention.

FIG. 11 is a diagram illustrating results of the charged/discharged power bias control according to the third embodiment of this invention.

FIG. 12 is a flow chart illustrating a charged/discharged power bias control routine executed by the inverter/converter controller according to the third embodiment of this invention.

FIG. 13 is a diagram illustrating possible variations of the charged/discharged power bias control in the third embodiment of this invention.

### DESCRIPTION OF THE PREFERRED EMBODIMENTS

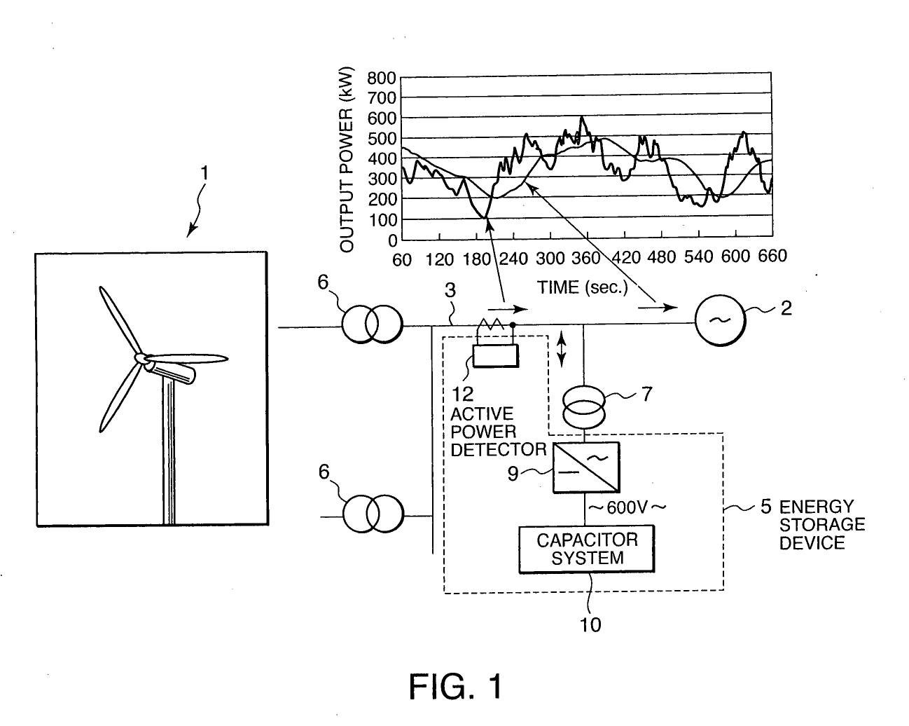

Referring to FIG. 1 of the drawings, a wind power generation system comprises a wind power generator 1 which generates electric power by wind energy, a power transmission route 3 along which power outputted by the wind generator 1 is fed to an electric power system 2 via a transformer 6, and an energy storage device 5, which is connected to the power transmission route 3 via a transformer 7.

The energy storage device 5 comprises a capacitor system 10 which is composed of a predetermined number of electric double layer capacitor cells, an inverter/converter 9 which charges and discharges the capacitor system 10, and an active power detector 12 which detects an output power of the wind power generator 1.

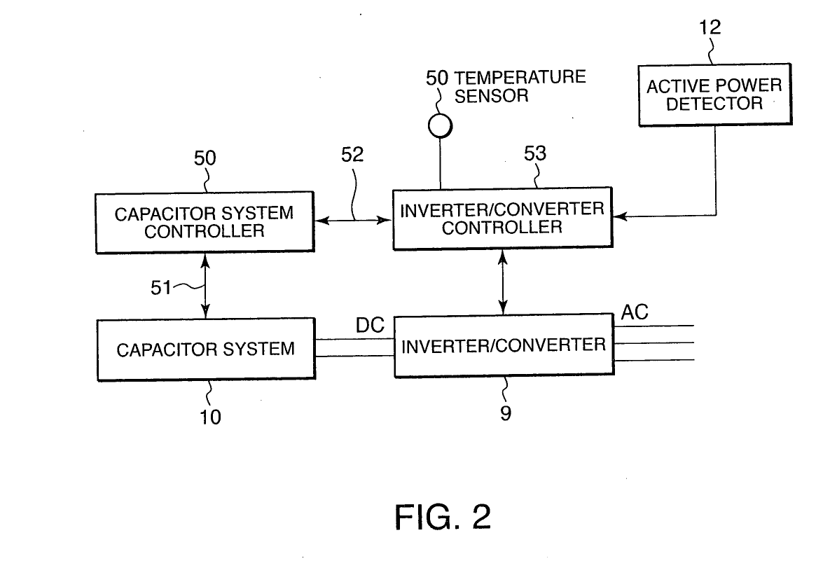

Referring to FIG. 2, the energy storage device 5 further comprises an inverter/converter controller 53 and a capacitor system controller 50.

The capacitor system controller 50 controls the capacitor system 10 via a signal line 51 in order to even out the charge/discharge amount among many capacitor modules that constitute the capacitor system 10. The capacitor system controller 50 also detects a trouble inside the capacitor system 10 and outputs a corresponding signal to the inverter/converter controller 53 via a signal line 52.

The inverter/converter controller 53 controls the operation of the inverter/converter 9 according to a detected value of the active power detector 12 to compensate for output power fluctuations of the wind power generator 1. In this control, the inverter/converter controller 53 performs charged/discharged power limitation in order to avoid overcharging and overdischarging of the capacitor system 10.

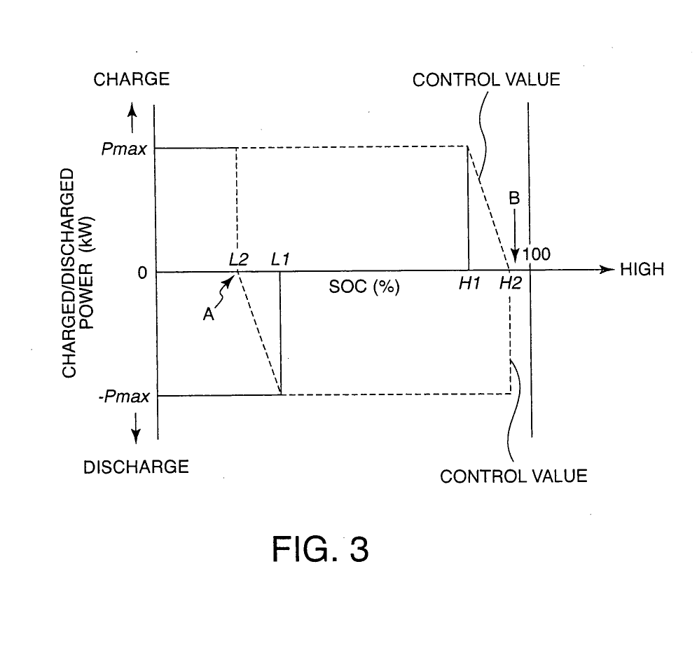

Referring to FIG. 3, for the state of charge (hereinafter abbreviated as SOC) of the capacitor system 10, the upper limit is set to H2 (%) and the lower limit is set to L2 (%). An upper threshold H1 (%), which is smaller than the upper limit H2, and a lower threshold L1 (%), which is greater than the lower limit L2, are set as thresholds of charged/discharged power limitation control. L1, L2, H1 and H2 are, for example, 40 (%), 30 (%), 90 (%), 95 (%), respectively. H1 and L1 therefore satisfy a relation H1>L1.

The axis of abscissa shows the SOC. Above a point zero on the axis of ordinate, a state in which the capacitor system 10 is receiving an input of power, in other words, a charge state is indicated by a positive value, whereas a negative value indicates a state in which the capacitor system 10 is outputting power, in other words, a discharge state below the point zero.

Input limitation control in charging the capacitor system 10 will be described first.

At a point A in the drawing, the charged/discharged power of the capacitor system 10 is zero kilowatt (kW), and the SOC equals to the lower limit L2.

The inverter/converter controller 53 gives the capacitor system 10 in this state a maximum input power Pmax (kW), for example, to start charging the capacitor system 10. The SOC rises as the charging continues. The inverter/converter controller 53 controls the charge input power to the capacitor system 10 such that, once the SOC reaches the upper threshold H1, which is lower than the upper limit H2, the charge input power is gradually reduced until it becomes zero kW at the same time when the SOC reaches the upper limit H2.

Output limitation control in discharging the capacitor system 10 will be described next.

At a point B in the drawing, the charged/discharged power of the capacitor system 10 is zero kW, and the SOC equals to the upper limit H2.

The inverter/converter controller 53 causes the capacitor system 10 in this state to make a maximum output power −Pmax for example, to start discharging the capacitor system 10. The SOC lowers as the discharging continues. The inverter/converter controller 53 controls the discharge output power of the capacitor system 10 such that, once the SOC reaches the lower threshold L1, which is higher than the lower limit L2, the discharge output power is gradually reduced until it becomes zero kW at the same time when the SOC reaches the lower limit L2.

The SOC of the capacitor system 10 is calculated from the terminal voltage of the capacitor system 10 with the use of the above Expression (1).

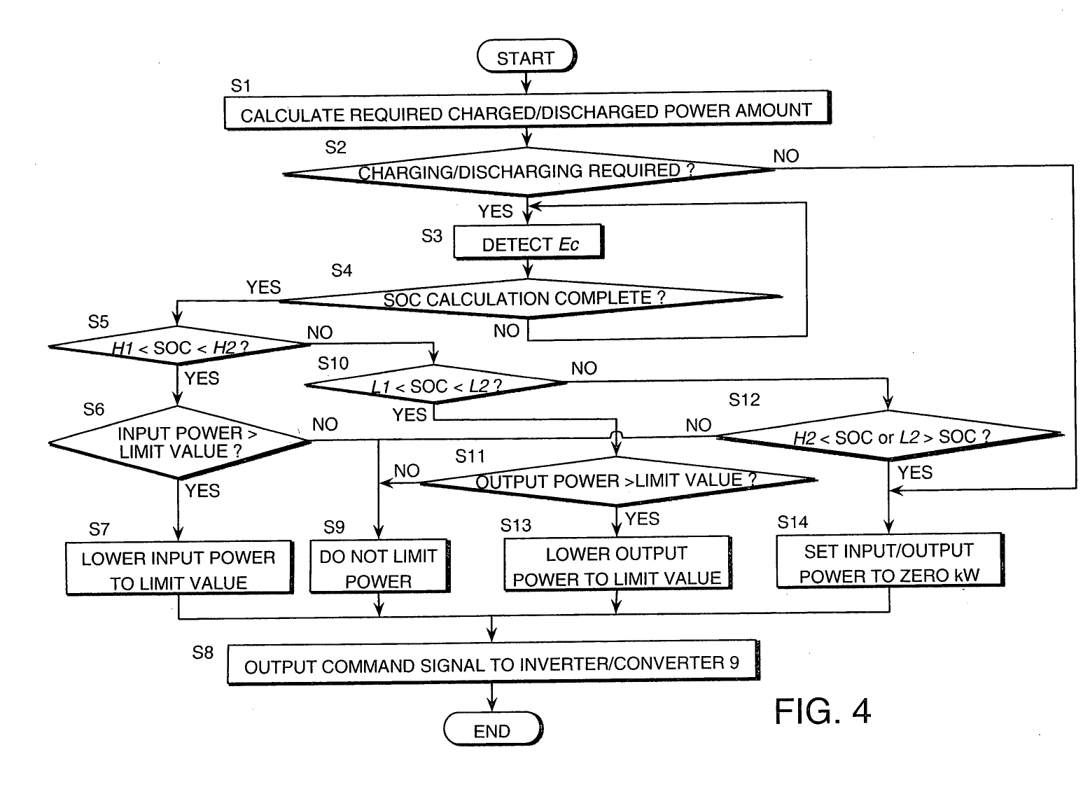

Referring to FIG. 4, a charged/discharged power limitation control routine that is executed by the inverter/converter controller 53 in order to implement the above control will be described. This routine is carried out at given time intervals, for example, at 10-millisecond intervals, while the wind power generation system is in operation.

First, in a step S1, the inverter/converter controller 53 calculates an amount of power the capacitor system 10 needs to charge or discharge to stabilize the output power of the wind power generation system based on the difference between the generated power of the wind power generator 1 and an objective generated power, as a required charged/discharged power.

In a step S2, the inverter/converter controller 53 determines from the required charged/discharged power whether or not charging or discharging of the capacitor system 10 is required. When neither charging nor discharging is required, the inverter/converter controller 53 generates in a step S14 a command signal for turning the charged/discharged power to zero kW. In a next step S8, the inverter/converter controller 53 outputs the command signal to the inverter/converter 9 and then ends the routine.

When charging or discharging is required, the inverter/converter controller 53 detects in a step S3 a terminal voltage Ec of the capacitor system 10, and calculates from the terminal voltage Ec the SOC of the capacitor system 10. In a next step S4, the inverter/converter controller 53 determines whether or not the calculation of the SOC of the capacitor system 10 based on the terminal voltage Ec has been completed. In a case where the SOC calculation has not been completed yet, the inverter/converter controller 53 continues the SOC calculation in the step S3.

When it is determined in the step S4 that the SOC calculation has been completed, the inverter/converter controller 53 determines in a step S5 whether or not the calculated SOC is less than the upper limit H2 and exceeds the upper threshold H1, which is lower than the upper limit H2.

When the determination in the step S5 is affirmative, the inverter/converter controller 53 compares in a step S6 the charge input power to the capacitor system 10 against a limit value set according to the SOC.

The limit value set according to the SOC here is a value for gradually lowering the charge input power to the capacitor system 10. As shown in FIG. 3, this limit value is set such that the charge input power to the capacitor system 10 is reduced as the SOC increases from the upper threshold H1 to the upper limit H2. The limit value is determined by correcting the charge input power at the upper threshold H1 downward according to the SOC. Alternatively, a limit value table may be created in advance in association with SOC values between the upper threshold H1 and the upper limit H2, so the limit value is directly obtained by searching the table with the SOC as a key.

When the charge input power to the capacitor system 10 exceeds the limit value in the step S6, there is a fear of an overcharge in which the SOC exceeds the upper limit H2. In this case, the inverter/converter controller 53 generates in a step S7 a command signal for lowering the charge input power to the capacitor system 10 down to the limit value. In the next step S8, the inverter/converter controller 53 outputs the command signal to the inverter/converter 9 and then ends the routine.

When the charge input power to the capacitor system 10 does not exceed the limit value in the step S6, there is no fear that the capacitor system 10 is overcharged. In this case, the inverter/converter controller 53 generates in a step S9 a command signal that does not limit the charge input/discharge output power. In the next step S8, the inverter/converter controller 53 outputs the command signal to the inverter/converter 9 and then ends the routine.

In a case where the determination in the step S5 is negative, the inverter/converter controller 53 determines in a step S10 whether or not the calculated SOC is greater than the lower limit L2 of the SOC and smaller than the lower threshold L1, which is greater than the lower limit L2.

When the determination in the step S10 is affirmative, the inverter/converter controller 53 compares in a step S11 the discharge output power of the capacitor system 10 against a limit value set according to the SOC. The limit value set according to the SOC is set such that the discharge output power of the capacitor system 10 is reduced as the SOC decreases from the lower threshold L1 to the lower limit L2 in FIG. 3. The limit value is determined by correcting the discharge output power at the lower threshold L1 downward according to the SOC. Alternatively, a limit value table may be created in advance in association with SOC values between the lower threshold L1 and the lower limit L2, so the limit value is obtained by searching the table with the SOC as a key.

When the discharge output power of the capacitor system 10 exceeds the limit value in the step S11, there is a fear of an overdischarge in which the SOC is lower than the lower limit L2. In this case, the inverter/converter controller 53 generates in a step S13 a command signal for lowering the discharge output power of the capacitor system 10 down to the limit value. In the next step S8, the inverter/converter controller 53 outputs the command signal to the inverter/converter 9 and then ends the routine.

When the discharge output power of the capacitor system 10 does not exceed the limit value in the step S11, there is no fear that the capacitor system 10 is overdischarged. In this case, the inverter/converter controller 53 generates in the step S9 described above a command signal that does not limit the charge input/discharge output power. In the next step S8, the inverter/converter controller 53 outputs the command signal to the inverter/converter 9 and then ends the routine.

When the determination in the step S10 is negative, the inverter/converter controller 53 determines in a step S12 whether or not the SOC fulfills one of two conditions:

1) the SOC is greater than the upper limit H2; and

2) the SOC is lower than the lower limit L2.

When the determination in the S12 is affirmative, the inverter/converter controller 53 generates in the step S14 described above a command signal for turning the charge input power or the discharge output power to zero kW. In the next step S8, the inverter/converter controller 53 outputs the command signal to the inverter/converter 9 and then ends the routine.

When the determination in the step S12 is negative, the SOC of the capacitor system 10 is within the range between the lower threshold L1 and the upper threshold H1. In this case, the inverter/converter controller 53 generates in the step S9 described above a command signal that does not limit the charge input/discharge output power. In the next step S8, the inverter/converter controller 53 outputs the command signal to the inverter/converter 9 and then ends the routine.

By executing the routine, the charge input power or the discharge output power is gradually lowered before the SOC of the capacitor system 10 reaches the upper limit H2 or the lower limit L2 and the charge input power or the discharge output power becomes zero at the time the SOC reaches the upper limit H2 or the lower limit L2.

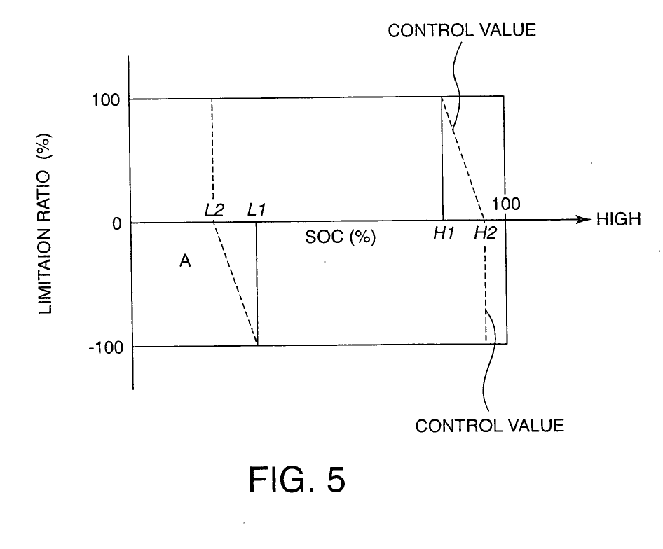

Overcharging and overdischarging of the capacitor system 10 can thus be prevented by this routine without failure. As a result, the electric double layer capacitor energy storage device containing the energy storage device 5 including the capacitor system 10, can be free of maintenance and can have a high durability. In the above description, limit values are set for the charge input power and discharge output power of the capacitor system 10 according to the SOC of the capacitor system 10. As shown in FIG. 5, the limit values may be replaced by a limitation ratio with the maximum input power Pmax of the capacitor system 10 expressed as 100% and a limitation ratio with the maximum Output power −Pmax of the capacitor system 10 expressed as 100%.

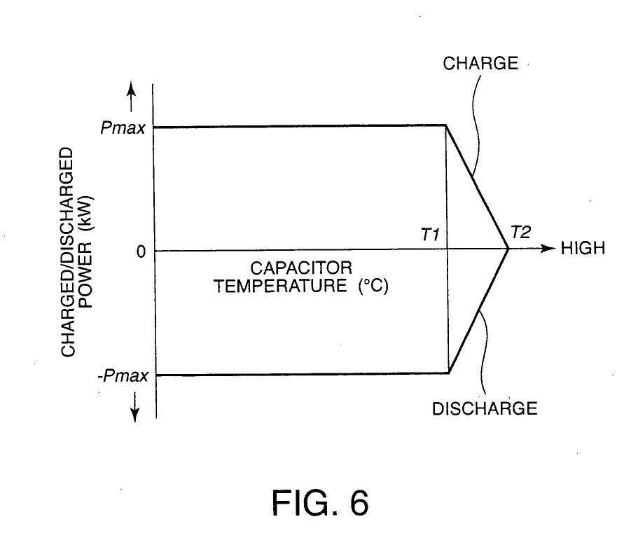

Referring to FIGS. 6-8, a second embodiment of this invention will be described.

In this embodiment, the charged/discharged power is controlled with the use of limit values with respect to the temperature of the capacitor system 10 instead of the use of limit values with respect to the SOC. For this purpose, a temperature sensor 54 shown in FIG. 2 for detecting a temperature Tc (° C.) of the capacitor system 10 is connected to the inverter/converter controller 53.

FIG. 6 shows that the upper limit to the temperature of the capacitor system 10 is T2 (° C.), and a value lower than the upper limit T2 is set as a threshold T1 (° C.) for output power limitation. As in FIG. 3, above a point zero on the axis of ordinate, a state in which the capacitor system 10 is receiving a charge input power, in other words, a charge state is indicated by a positive value, whereas a negative value indicates a state in which the capacitor system 10 is outputting a discharge output power, in other words, a discharge state.

This embodiment is built on characteristics of the capacitor system 10 in that the temperature Tc of the capacitor system 10 rises while charging or discharging of the capacitor system 10 continues. In other words, charging and discharging are possible while the temperature of the capacitor system 10 is low, whereas there is a risk of overcharge or overdischarge when the temperature Tc of the capacitor system 10 exceeds the upper limit T2.

When the temperature Tc of the capacitor system 10 is less than the threshold T1, the maximum value ±Pmax of the charge input power to or the discharge output power from the capacitor system 10 is employed in charging or discharging the capacitor system 10. As charging or discharging continues, the temperature Tc of the capacitor system 10 rises. The inverter/converter controller 53 controls the inverter/converter 9 such that, when the temperature Tc reaches the threshold T1, which is lower than the upper limit T2, the charge input power to or the discharge output power from the capacitor system 10 is gradually reduced until the charge input power to or the discharge output power from the capacitor system 10 becomes zero kW at the same time when the temperature Tc reaches T2.

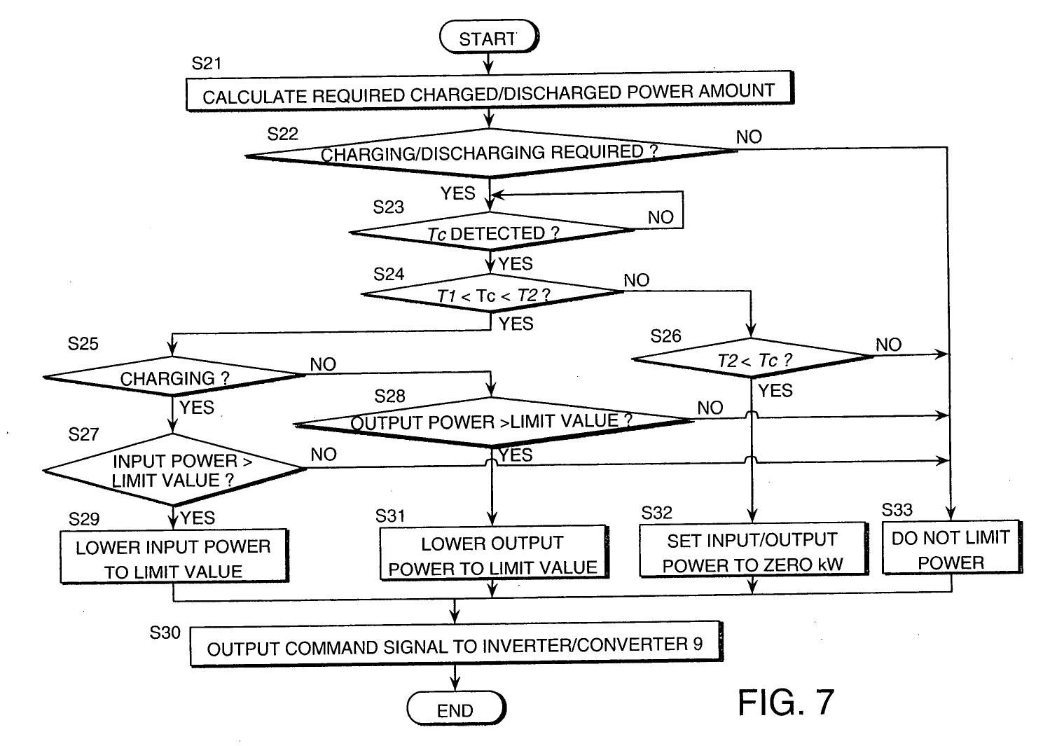

FIG. 7 shows a charged/discharged power limitation control routine that is executed by the inverter/converter controller 53 in order to implement the above control. This routine is carried out at given time intervals, for example, at 10-millisecond intervals, while the wind power generation system is in operation.

First, in a step S21, the inverter/converter controller 53 calculates an amount of power the capacitor system 10 needs to charge or discharge in order to stabilize the output power of the wind power generation system based on the difference between the generated power of the wind power generator 1 and an objective generated power, as a required charged/discharged power.

In a step S22, the inverter/converter controller 53 determines from the required charged/discharged power whether or not charging or discharging of the capacitor system 10 is required.

When neither charging nor discharging is required, the inverter/converter controller 53 generates in a step S33 a command signal that does not limit the charge input power or the discharge output power. In a next step S30, the inverter/converter controller 53 outputs the command signal to the inverter/converter 9 and then ends the routine.

When charging or discharging is required, the inverter/converter controller 53 detects in a step S23 the temperature Tc of the capacitor system 10 based on a signal input from the temperature sensor 54. The inverter/converter controller 53 repeats the processing of the step S23 until the temperature Tc is detected.

Detecting the temperature Tc of the capacitor system 10, the inverter/converter controller 53 determines in a next step S24 whether or not the temperature Tc is less than the upper limit T2 and exceeds the threshold T1, which is lower than the upper limit T2.

When the determination in the step S24 is affirmative, the inverter/converter controller 53 determines in a step S25 whether or not the capacitor system 10 is undergoing a charging operation. This can be determined based on the terminal voltage Ec.

When the capacitor system 10 is in the process of a charging operation, the inverter/converter controller 53 compares in a step S27 the charge input power to the capacitor system 10 against a limit value set according to the temperature Tc of the capacitor system 10.

The limit value set according to the temperature Tc of the capacitor system 10 is a value for gradually lowering the charge input power to the capacitor system 10. As shown in FIG. 6, this limit value is set such that the charge input power to the capacitor system 10 is reduced as the temperature Tc of the capacitor system 10 increases from the threshold T1 to the upper limit T2. The limit value is determined by correcting the charge input power at the threshold T1 downward according to the temperature Tc of the capacitor system 10. Alternatively, a limit value table may be created in advance in association with values of the temperature Tc of the capacitor system 10 between the threshold T1 and the upper limit T2, so the limit value is directly obtained by searching the table with the temperature Tc of the capacitor system 10 as a key.

When the charge input power to the capacitor system 10 exceeds the limit value in the step S27, there is a fear of an overcharge in which the temperature Tc of the capacitor system 10 exceeds the upper limit T2. In this case, the inverter/converter controller 53 generates in a step S29 a command signal for lowering the charge input power to the capacitor system 10 down to the limit value. In the next step S30, the inverter/converter controller 53 outputs the command signal to the inverter/converter 9 and then ends the routine.

When the charge input power to the capacitor system 10 does not exceed the limit value in the step S27, there is no fear that the capacitor system 10 is overcharged. In this case, the inverter/converter controller 53 generates in the step S33 described above a command signal that does not limit the charged/discharged power. In the next step S30, the inverter/converter controller 53 outputs the command signal to the inverter/converter 9 and then ends the routine.

When the capacitor system 10 is not in the process of a charging operation in the step S25, it means that the capacitor system 10 is undergoing a discharging operation. In this case, the inverter/converter controller 53 compares in a step S28 the discharge output power from the capacitor system 10 against a limit value set according to the temperature Tc of the capacitor system 10. The limit value set according to the temperature Tc of the capacitor system 10 is a value for gradually lowering the discharge output power from the capacitor system 10.

As shown in FIG. 6, this limit value is set such that the discharge output power from the capacitor system 10 is reduced as the temperature Tc of the capacitor system 10 increases from the threshold T1 to the upper limit T2. The limit value is determined by correcting the discharge output power at the threshold T1 downward according to the temperature Tc of the capacitor system 10.

Alternatively, a limit value table may be created in advance in association with values of the temperature Tc of the capacitor system 10 between the threshold T1 and the upper limit T2, so the limit value is directly obtained by searching the table with the temperature Tc of the capacitor system 10 as a key.

When the discharge output power from the capacitor system 10 exceeds the limit value in the step S28, there is a fear of an overdischarge in which the temperature Tc of the capacitor system 10 exceeds the upper limit T2. In this case, the inverter/converter controller 53 generates in a step S31 a command signal for lowering the discharge output power from the capacitor system 10 down to the limit value. In the next step S30, the inverter/converter controller 53 outputs the command signal to the inverter/converter 9 and then ends the routine.

When the discharge output power from the capacitor system 10 does not exceed the limit value in the step S28, there is no fear that the capacitor system 10 is overdischarged. In this case, the inverter/converter controller 53 generates in the step S33 described above a command signal that does not limit the charge input/discharge output power. In the next step S30, the inverter/converter controller 53 outputs the command signal to the inverter/converter 9 and then ends the routine.

When the determination in the S24 is negative, the inverter/converter controller 53 determines in a step S26 whether or not the temperature Tc of the capacitor system 10 exceeds the upper limit T2.

When the temperature Tc of the capacitor system 10 exceeds the upper limit T2 in the step S26, there is a risk of overcharge or overdischarge. In this case, the inverter/converter controller 53 generates in a step S32 a command signal for turning the charge input/discharge output power to zero kW. In the next step S30, the inverter/converter controller 53 outputs the command signal to the inverter/converter 9 and then ends the routine.

When the temperature Tc of the capacitor system 10 does not exceed the upper limit T2 in the step S26, it means, in conjunction with the determination in the step S24, that the temperature Tc of the capacitor system 10 is equal to or lower than the threshold T1.

In this case, the inverter/converter 9 generates in the step S33 described above a command signal that does not limit the charged/discharged power. In the next step S30, the inverter/converter controller 53 outputs the command signal to the inverter/converter 9 and then ends the routine.

By executing the routine, the charge input power or the discharge output power is gradually lowered before the temperature Tc of the capacitor system 10 reaches the upper limit T2 and the charge input power or the discharge output power becomes zero kW at the time the temperature Tc reaches the upper limit T2.

Therefore, according also to this routine, overcharging or overdischarging of the capacitor system 10 is prevented without failure.

In this embodiment, limit values are set for the charge input power and discharge output power of the capacitor system 10 according to the temperature Tc of the capacitor system 10.

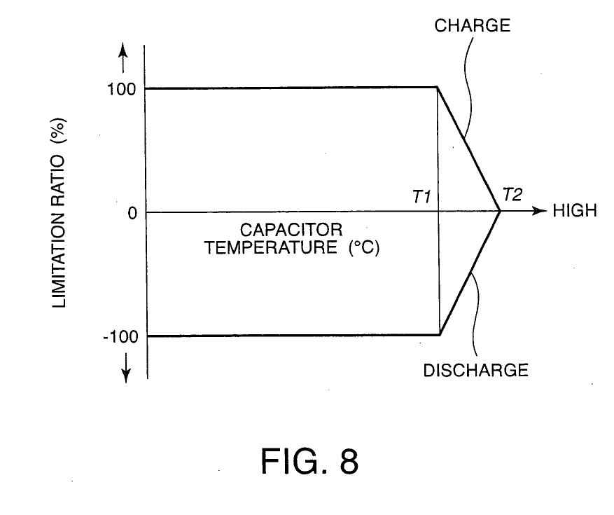

Referring to FIG. 8, the limit values may be replaced by a limitation ratio with respect to the maximum input power Pmax of the capacitor system 10 expressed as 100% and a limitation ratio with respect to the maximum output power −Pmax of the capacitor system 10 expressed as 100%.

The limit value calculation according to the first embodiment and the limit value calculation according to the second embodiment may both be executed, and a smaller limit value of the two calculation results may be employed. Calculating the limit value by two different methods in this manner improves the precision of charge input/discharge output power limitation control.

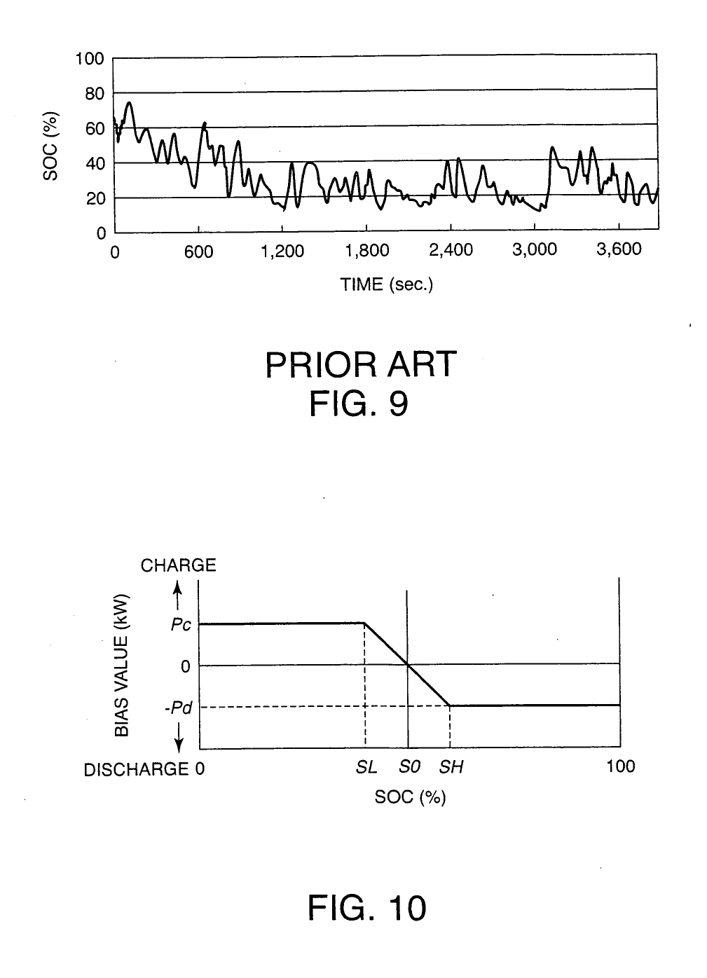

Referring to FIGS. 9-11, a third embodiment of this invention will be described.

The first and second embodiments make the energy storage device 5 which has the capacitor system 10 free of maintenance and prolong the lifetime of the energy storage device 5 by executing charge input power limitation control and discharge output power limitation control.

On the other hand, the power stabilizing performance of the energy storage device 5 can be improved by efficiently utilizing the storage capacity of the capacitor system 10 and thus increasing the charge input power or discharge output power of the capacitor system 10.

The third embodiment relates to bias control of the energy storage device 5 to raise a mean SOC in order to fully utilize the storage capacity of the capacitor system 10.

FIG. 9 shows the relation between a running time of the capacitor system 10 and the SOC of the capacitor system 10 without bias control. As shown in the figure, the SOC lowers as the running time becomes longer, and the SOC fluctuates around 20%. A cause of this is a great power loss in charging resulting from a loss in charging the capacitor system 10 and a loss in making an input power to and output power from the inverter/converter 9. When only 20% of the storage capacity of the capacitor system 10 is used as in the case of this example, the SOC frequently reaches its lower limit L2 described in the first embodiment and the probability of the discharge output power being limited becomes accordingly higher. As a result, not enough effect of stabilization control is obtained.

In this embodiment, a given bias output (kW) is added to or subtracted from a charge input power and a discharge output power that are required for power stabilization so that the SOC of the capacitor system 10 can be kept at a given higher level.

FIG. 10 shows that, in this embodiment, a bias value Pc for charging is added to the charge input power when the SOC value is less than a threshold SL whereas a bias value −Pd for discharging is added to the discharge output power when the SOC value exceeds a threshold SH.

When the SOC is within a given range between SL and SH which includes a median value S0, the bias value is set according to the difference between the SOC and the median value S0. When the SOC is outside this range, the bias value is set to the fixed value Pc or −Pd.

However, the bias value is not limited to those characteristics and various other settings can be employed to reach the median value S0. The fixed values Pc and −Pd are set to appropriate values that make the SOC converge to the median value S0 without impairing the power stabilization effect.

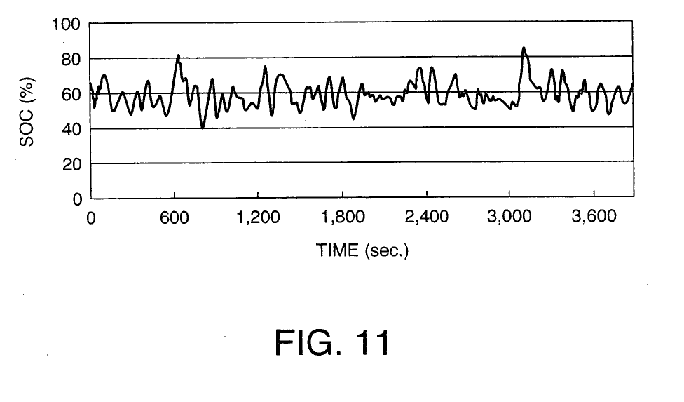

Setting the bias value according to the SOC of the capacitor system 10 in this manner makes the SOC readily converge to the median value S0 as shown in FIG. 11. Herein, the median value S0 is set equal to 60% of the storage capacity of the capacitor system 10. A bias value required for a corrective shift from the state of FIG. 9 to the state of FIG. 11 is the bias value Pc of the charge input alone, and the setting of the bias value −Pd of the discharge output power is irrelevant to this shift. As opposed to FIG. 9, in a case where the SOC fluctuates around a value larger than the median value S0, the bias value −Pd of the discharge output power is used to correct this tendency. The setting of the bias value Pc of the charge input power is irrelevant to this fluctuation correction.

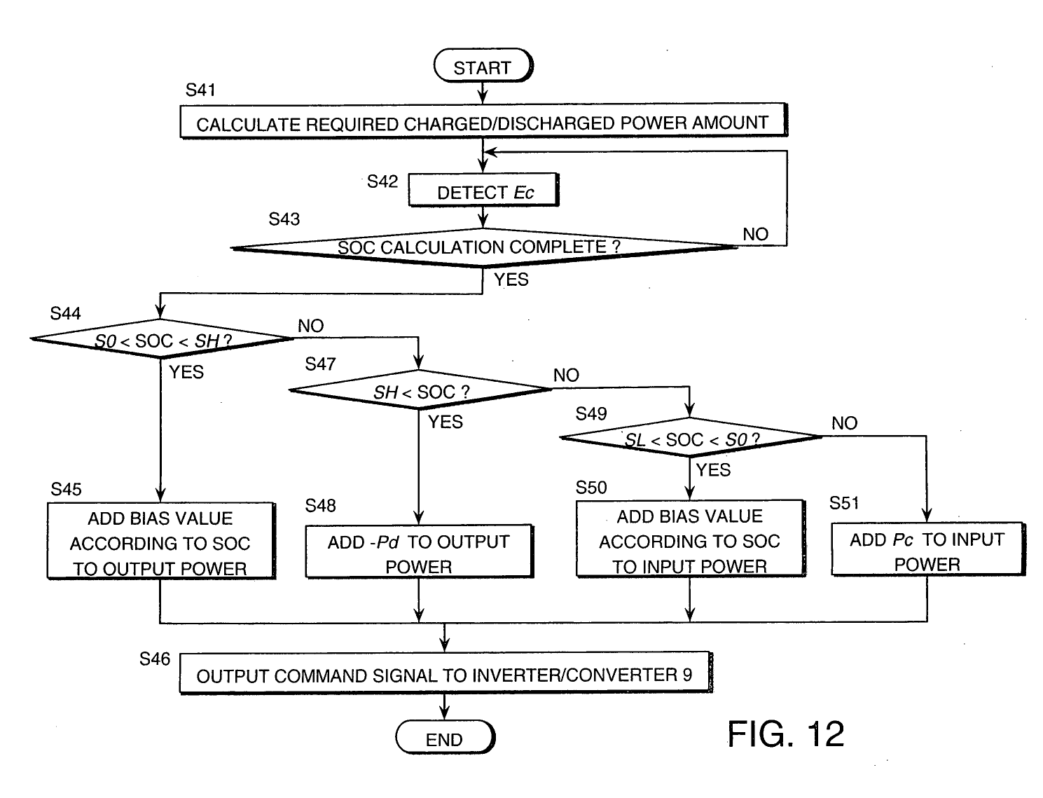

FIG. 12 shows a bias control routine that is executed by the inverter/converter controller 53 in order to implement the bias control described above. This routine is carried out at given time intervals, for example, at 10-millisecond intervals, while the wind power generation system is in operation.

First, in a step S41, the inverter/converter controller 53 calculates an amount of power the capacitor system 10 needs to charge or discharge to stabilize the output power of the wind power generation system based on the difference between the generated power of the wind power generator 1 and an objective generated power, as a required charged/discharged power.

In a next step S42, the inverter/converter controller 53 detects the terminal voltage Ec of the capacitor system 10, and calculates the SOC of the capacitor system 10 from the terminal voltage Ec.

Although the detection of the terminal voltage Ec of the capacitor system 10 is performed in every occasion when the routine is performed, the calculation of the SOC of the capacitor system 10 based on the detected terminal voltage Ec is preferably performed by applying smoothing processing, e.g. first order delay processing, in order to eliminate an effect of fluctuation in the terminal voltage Ec.

In a next step S43, the inverter/converter controller 53 determines whether the calculation of the SOC of the capacitor system 10 based on the terminal voltage Ec has been completed or not. In a case where the SOC calculation has not been completed yet, the inverter/converter controller 53 continues the SOC calculation in the step S43.

Determining in the step S43 that the SOC calculation has been completed, the inverter/converter controller 53 determines in a step S44 whether or not the calculated SOC is within a range between the median value S0 and the upper limit SH of the given range.

When the determination in the step S44 is affirmative, the inverter/converter controller 53 sets in a step S45 a bias value according to the SOC so that the bias value has the variation characteristics shown in FIG. 10. In addition, the inverter/converter controller 53 adds the set bias value to the discharge output power, and generates a command signal corresponding to the result of the addition.

It should be noted however that this calculation is performed only when the capacitor system 10 is discharging power, or in other words, when the required charged/discharged power calculated in the step S41 corresponds to a discharged power. When on the other hand the required charged/discharged power calculated in the step S41 corresponds to a charged power, the calculation of the discharge output power is omitted and the command signal is generated according to the requested charged power without correction.

In a next step S46, the inverter/converter controller 53 outputs the command signal to the inverter/converter 9 and then ends the routine.

The bias value is added to the discharge output power in the calculation in the step S45 where the discharge output power is expressed as a negative charge input power as can be seen in FIG. 3. The bias value is also expressed as a negative value as shown in FIG. 10 when the SOC exceeds the median value S0. Substantially the same result is obtained by another calculation method in which the bias value is calculated as an absolute value and the bias value is subtracted from a negative charge input power.

When the determination in the step S44 is negative, the inverter/converter controller 53 determines in a step S47 whether or not the SOC exceeds the upper limit SH of the given range.

When the SOC exceeds the upper limit SH of the given range in the step S47, the inverter/converter controller 53 adds in a step S48 the bias value −Pd shown in FIG. 10 to the discharge output power expressed as a negative value, and generates a command signal corresponding to the result of the addition.

It should also be noted however that this calculation is performed only when the capacitor system 10 is discharging power, or in other words, when the required charged/discharged power calculated in the step S41 corresponds to a discharged power. When on the other hand the required charged/discharged power calculated in the step S41 corresponds to a charged power, the calculation of the discharge output power is omitted and the command signal is generated according to the requested charged power without correction.

In the next step S46, the inverter/converter controller 53 outputs the command signal to the inverter/converter 9 and then ends the routine.

With respect to the calculation in the step S48 also, as in the case of the calculation in the step S45, the same result is obtained by subtracting an absolute bias value Pd from a negative charge input power.

When the SOC does not exceed the upper limit SH of the given range in the step S47, the inverter/converter controller 53 determines in a step S49 whether or not the SOC is within a range between the lower limit SL of the given range and the median value S0.

When the determination in the step S49 is affirmative, the inverter/converter controller 53 sets in a step S50 the bias value according to the SOC so that the bias value has the variation characteristics shown in FIG. 10. The inverter/converter controller 53 adds the set bias value to the charge input, and generates a command signal corresponding to the result of the addition.

It should be noted however that this calculation is performed only when the capacitor system 10 is charging power, or in other words, when the required charged/discharged power calculated in the step S41 corresponds to a charged power. When on the other hand the required charged/discharged power calculated in the step S41 corresponds to a discharged power, the calculation of the charge input power is omitted and the command signal is generated according to the requested discharged power without correction.

In the next step S46, the inverter/converter controller 53 outputs the command signal to the inverter/converter 9 and then ends the routine.

Again, substantially the same calculation result that is obtained through the calculation in the step S50 is obtained by another calculation method, for example, the discharge output power is expressed as a positive value and the charge input power is regarded as a negative discharge output power from which the bias value expressed as an absolute value is subtracted.

When the determination in the step S49 is negative, it means that the SOC is less than the lower limit SL of the given range.

In this case, the inverter/converter controller 53 adds in a step S51 the bias value Pc shown in FIG. 10 to the charge input power, and generates a command signal corresponding to the result of the addition.

It should also be noted however that this calculation is performed only when the capacitor system 10 is charging power, or in other words, when the required charged/discharged power calculated in the step S41 corresponds to a charged power. When on the other hand the required charged/discharged power calculated in the step S41 corresponds to a discharged power, the calculation of the charge input power is omitted and the command signal is generated according to the requested discharged power without correction.

In the next step S46, the inverter/converter controller 53 outputs the command signal to the inverter/converter 9 and then ends the routine.

Again, substantially the same calculation result that is obtained through the calculation in the step S52 is obtained by another calculation method, for example, the discharge output is expressed as a positive value and the charge input power is regarded as a negative discharge output power from which the bias value (Pc) expressed as an absolute value is subtracted.

According to this embodiment, the SOC of the capacitor system 10 can be converged to the favorable median value S0 by utilizing the capacitors' characteristics in that the SOC is detected from the voltage with precision and applying a bias value in charging or discharging of the capacitor system 10. As a result, the power loss is compensated and the capacity for the charge input power and the discharge output power is substantially enlarged, thereby improving the performance of the energy storage device 5 in stabilizing the power of the wind power generation system.

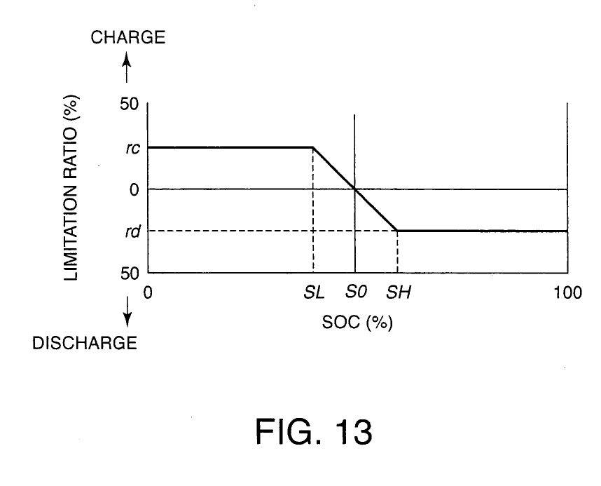

The bias power is set according to the SOC in this embodiment. An effect similar to when the bias power is employed is obtained by setting a bias ratio as shown in FIG. 13, instead of the bias power, and multiplying the charge input power of the capacitor system 10 and the discharge output power of the capacitor system 10 each by the bias ratio.

The contents of Tokugan 2005-305764, with a filing date of Oct. 20, 2005, are hereby incorporated by reference.

Although the invention has been described above with reference to certain embodiments of the invention, the invention is not limited to the embodiments described above. Modifications and variations of the embodiments described above will occur to those skilled in the art, within the scope of the claims.

For instance, other capacitors than electric double layer capacitors can be used for the capacitor system 10.

While the above embodiments apply this invention to the energy storage device 5 which is used in combination with a wind power generation system, this invention is also applicable to energy storage devices that are used in combination with other types of system.

This invention is applicable to any energy storage device with a capacitor that executes control as claimed by using a parameter, independent of how the parameter used for the control is obtained.

### INDUSTRIAL FIELD OF APPLICATION

An energy storage device according to this invention can be used in, in addition to wind power generation facilities, capacitor systems for hybrid trains, hybrid industrial vehicles, emergency power supplies for telephone switching stations which have conventionally been constructed from lead batteries, and the like.

The embodiments of this invention in which an exclusive property or privilege is claimed are defined as follows:

1. An energy storage device connected to a generator to stabilize output of the generator, comprising:
a capacitor system comprising a number of stacked capacitors;
an inverter/converter which selectively controls charging and discharging of the capacitor system; and
a programmable controller programmed to:
cause the inverter/converter, when an output power of the generator exceeds an objective level, to charge the capacitor system with an excess power of the generator;
cause the inverter/converter, when the output power of the generator is lower than the objective level, to make the capacitor system discharge power so as to compensate for a shortage of the output power of the generator;
determine a parameter representing a charging/discharging condition of the capacitor system, and
cause the inverter/converter, when the parameter exceeds a threshold that is set on a near side of a limit value, to make a charged power and a discharged power of the capacitor system decrease as the parameter approaches the limit value and equal zero when the parameter reaches the limit value.

2. The energy storage device as defined in claim 1, wherein the parameter is a state of charge of the capacitor system, the limit value is constituted of an upper limit value and a lower limit value of the state of charge, the threshold is constituted of an upper threshold which is smaller than the upper limit value, and a lower threshold which is larger than the lower limit value, and the programmable controller is further programmed to cause the inverter/converter, when the state of charge exceeds the upper threshold, to make the charged power of the capacitor system decrease as the state of charge approaches the upper limit value and equal zero when the state of charge reaches the upper limit value, and to cause the inverter/converter, when the charged power is lower than the lower threshold, to make the charged power decrease as the state of charge approaches the lower limit value and equal zero when the state of charge reaches the lower limit value.

3. The energy storage device as defined in claim 2, wherein the programmable controller is further programmed to calculate the state of charge of the capacitor system based on a terminal voltage of the capacitor system which is detected by the inverter/converter.

4. The energy storage device as defined in claim 1, wherein the parameter is a temperature of the capacitor system, and the programmable controller is further programmed to cause the inverter/converter, when the temperature of the capacitor system exceeds a threshold which is lower than a limit value, to make the charged power and discharged power of the capacitor system decrease as the temperature of the capacitor system approaches the limit value and equal zero when the temperature of the capacitor system reaches the limit value.

5. A control method for an energy storage device connected to a generator to stabilize output of the generator, the energy storage device comprising a capacitor system comprising a number of stacked capacitors, and an inverter/converter which selectively controls charging and discharging of the capacitor system, the method comprising:
causing the inverter/converter, when an output power of the generator exceeds an objective level, to charge the capacitor system with an excess power of the generator;
causing the inverter/converter, when the output power of the generator is lower than the objective level, to make the capacitor system discharge power so as to compensate for a shortage of the output power of the generator;
determining a parameter representing a charging/discharging condition of the capacitor system; and
causing the inverter/converter, when the parameter exceeds a threshold that is set on a near side of a limit value, to make a charged power and a discharged power of the capacitor system decrease as the parameter approaches the limit value and equal zero when the parameter reaches the limit value.

6. An energy storage device connected to a generator to stabilize an output power of the generator, comprising:
a capacitor system comprising a number of stacked capacitors;
an inverter/converter which selectively controls charging and discharging of the capacitor system; and
a programmable controller programmed to:
cause the inverter/converter, when the output power of the generator exceeds an objective level, to charge the capacitor system with an excess power of the generator;
cause the inverter/converter, when the output power of the generator is lower than the objective level, to cause the capacitor system to discharge power so as to compensate for a shortage of the output power of the generator;
determine a state of charge of the capacitor system;
cause the inverter/converter, when the state of charge is higher than a median value, to cause the capacitor system to increase the discharged power by adding a first bias value; and
cause the inverter/converter, when the state of charge is lower than the median value, to cause the capacitor system to increase the charged power of the capacitor system by adding a second bias value.

7. The energy storage device as defined in claim 6, wherein the programmable controller is further programmed to increase the first bias value as a difference between the state of charge and the median value increases, and set the first bias value to a fixed value when the difference between the state of charge and the median value is equal to or greater than a given value, and to increase the second bias value as a difference between the state of charge and the median value increases, and set the second bias value to a fixed value when the difference between the state of charge and the median value is equal to or larger than the given value.

8. The energy storage device as defined in claim 6, wherein the programmable controller is further programmed to determine the state of charge of the capacitor system from a terminal voltage of the capacitor system by applying smooth processing on values corresponding to detected terminal voltages of the capacitor system.

9. A control method for an energy storage device connected to a generator to stabilize an output power of the generator, the energy storage device comprising a capacitor system, including a number of stacked capacitors and an inverter/converter, which selectively controls charging and discharging of the capacitor system, the method comprising:
causing the inverter/converter, when the output power of the generator exceeds an objective level, to charge the capacitor system with an excess power of the generator;
causing the inverter/converter, when the output power of the generator is lower than the objective level, to cause the capacitor system to discharge power so as to compensate for a shortage of the output power of the generator;
determining a state of charge of the capacitor system;
causing the inverter/converter, when the state of charge is higher than a median value, to cause the capacitor system to increase the discharged power by adding a first bias value; and
causing the inverter/converter, when the state of charge is lower than the median value, to cause the capacitor system to increase the charged power of the capacitor system by adding a second bias value.

10. An energy storage device connected to a generator to stabilize output of the generator, comprising:
a capacitor system comprising a number of stacked capacitors;
an inverter/converter which selectively controls charging and discharging of the capacitor system;
means for causing the inverter/converter, when an output power of the generator exceeds an objective level, to charge the capacitor system with an excess power of the generator;
means for causing the inverter/converter, when the output power of the generator is lower than the objective level, to make the capacitor system discharge power so as to compensate for a shortage of the output power of the generator;
means for determining a parameter representing charging/discharging condition of the capacitor system, and
means for causing the inverter/converter, when the parameter exceeds a threshold that is set on a near side of a limit value, to make a charged power and a discharged power of the capacitor system decrease as the parameter approaches the limit value and equal zero when the parameter reaches the limit value.

11. An energy storage device connected to a generator to stabilize an output power of the generator, comprising:
a capacitor system comprising a number of stacked capacitors;
an inverter/converter which selectively controls charging and discharging of the capacitor system;
means for causing the inverter/converter, when the output power of the generator exceeds an objective level, to charge the capacitor system with an excess power of the generator;
means for causing the inverter/converter, when the output power of the generator is lower than the objective level, to cause the capacitor system to discharge power so as to compensate for a shortage of the output power of the generator;
means for determining a state of charge of the capacitor system;
means for causing the inverter/converter, when the state of charge is higher than a median value, to cause the capacitor system to increase the discharged power by adding a first bias value; and
means for causing the inverter/converter, when the state of charge is lower than the median value, to cause the capacitor system to increase the charged power of the capacitor system by adding a second bias value.
